(19) United States
(12) Patent Application Publication
(10) Pub. No.: US 2014/0134552 A1
(43) Pub. Date: May 15, 2014

(54) Method and Apparatus for Controlled Candle Care

(71) Applicants: Melissa Trevino, Carrollton, TX (US); Guillermo Trevino, Carrollton, TX (US)

(72) Inventors: Melissa Trevino, Carrollton, TX (US); Guillermo Trevino, Carrollton, TX (US)

(21) Appl. No.: 13/674,891

(22) Filed: Nov. 12, 2012

(51) Int. Cl. F23Q 25/00; B23P 11/00

(52) U.S. Cl. CPC F23Q 25/00; B23P 11/00
USPC 431/152; 29/428

(57) ABSTRACT

The present invention relates to a method of making a Candle Caddy. The method of making a Candle Caddy is attaching a timer to a platform that will shift the pole, which will also be attached to the platform and timer, once the timer goes of. The shift will cause the seal to slide down and turn off the candle.

### FIELD OF THE INVENTION

The present invention relates generally to the field of house wares and home decor. It makes candles much safer to use. The product's purpose is primarily to address the safety of candle usage, in a way that the “safety device” is also decorative.

### BACKGROUND OF THE INVENTION

Candle use is something that restaurants and homes take a big part in and that can inevitably put people in danger if they are not careful. Unattended candles or flames can and have caused many fires that have injured or even killed people and damaged property. Regardless of that fact, people still continue to use candles because they are enjoyable and decorative. Many people like to enjoy a candle with dinner, a bath, or a nap, but this can create a problem as distracted people can leave the candle running longer than intended. Using a platform and a timer to time when the lid will shut by either dropping down or sliding closed to keep oxygen out, and turn out the candle would solve these problems if used correctly.

Candles are very popular around the world but have to be used very carefully to avoid any dangerous situations. The present invention may open the doors to further usage because it will be safer and people will feel more comfortable leaving their candles on while they are distracted by the t.v., work, etc. By allowing candles to be safer products they could be used more often and more comfortably. The following product could make candles more user friendly in homes, restaurants, spas, and more.

There are timed candles that are programmed to turn off at a certain amount of time has passed, but these are all electronic candles with electronic flames that do not give off the same sensations as a real candle. There are also candles that have lines drawn on them to tell you how long the candle has been lit for or how long it will last based on where the wax is. However, there is nothing that can allow the consumer to set a particular time and have a real candle turn off after the time has elapsed. For this reason a product that could allow a candle to be used in a more controlled and safe environment would be desirable to a consumer who would like to use a candle and worry less about the safety issue.

Therefore, there is a need to provide a controlled and safer device for candles to be used more safely and decrease the number of dangerous fires and situations due to unattended or ignored flames and candles.

### SUMMARY

The foregoing needs are met, to a great extent, by the present invention, wherein in some embodiments, a method and an apparatus for controlled candle care are provided.

An embodiment of the present invention relates to an apparatus for controlled candle care. The apparatus for controlled care comprises a base, a rod that extends from the base, a mechanical arm that extends from the base, a timer that controls the mechanical arm with a motor, and a lid that extends from the mechanical arm, and a candle. The rod that extends from the base is adjustable to match the height of the candle. The mechanical arm that extends from the base is adjustable to match the location of the candle. The lid that extends from the mechanical arm is cone shaped. The lid that extends from the mechanical arm may also be flat shaped.

Another embodiment of the present invention relates to a method of making a controlled candle care apparatus comprising: providing a base for a candle; placing a timer that controls a mechanical arm that extends from a rod; placing a lid that extends from the mechanical arm; and manipulating the timer that controls the mechanical arm to designate a time in which the mechanical arm swings the lid to cover the candle's top. The method of making a controlled candle care apparatus further comprises the rod which is adjustable to match the height of the candle. The method of making a controlled candle care apparatus further comprises a mechanical arm which is adjustable to match the location of the candle.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for other methods for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

The novel features believed characteristic of the invention are set forth in the appended claims. The present invention and other attributes of the invention can best be understood in connection with the accompanying drawing in which:

FIG. 1 is a diagram depicting a candle lit on the present invention in use, an embodiment of the current invention;

FIG. 2 is a diagram depicting the movement of the mechanical arm with the lid of the present invention, an embodiment of the current invention;

FIG. 3 is a a diagram depicting the current invention, an embodiment of the current invention, covering the candle; and

FIG. 4 is a block diagram depicting the method of making the current invention.

### DETAILED DESCRIPTION OF EXEMPLARY EMBODIMENTS

In the following detailed description of the illustrative embodiments, reference is made to the accompanying drawings that form a part hereof. These embodiments are described in sufficient detail to enable those skilled in the art to practice the invention, and it is understood that other embodiments may be utilized and that logical structural, mechanical, electrical, and chemical changes may be made without departing the spirit or scope of the invention. To avoid detail not necessary to enable those skilled in the art to practice the embodiments, the description may omit certain information known to those skilled in the art. The following detailed description is, therefore, not to be taken in a limiting sense.

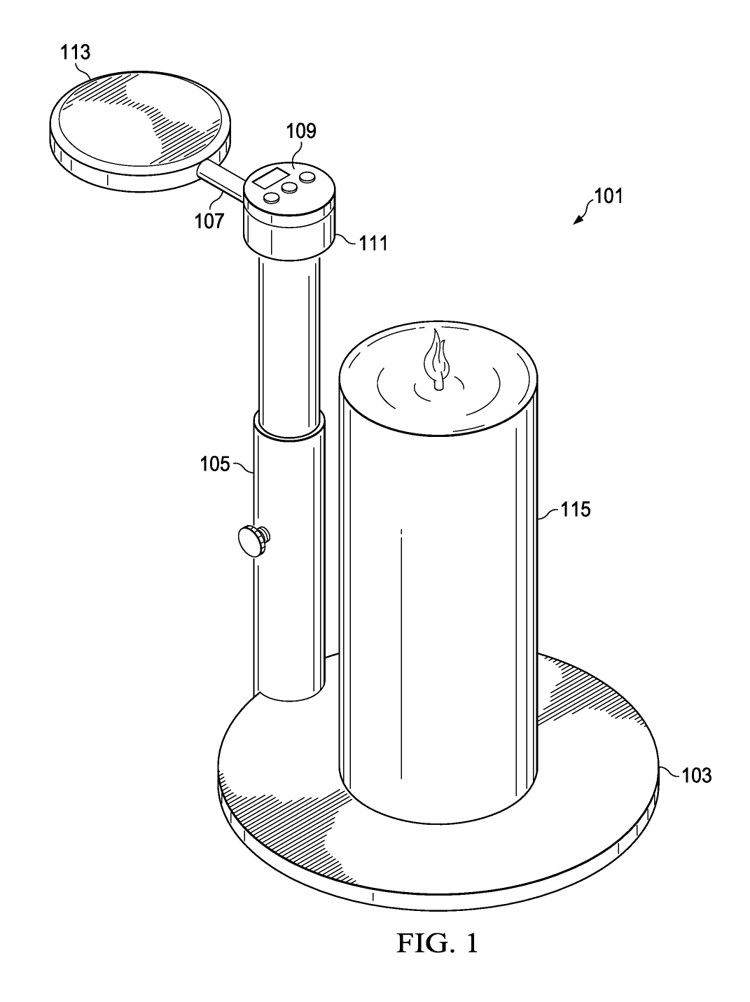

With reference now to FIG. 1 a diagram depicting a candle lit on the present invention in use, an embodiment of the current invention. The controlled candle care apparatus 101 comprises base 103, rod 105 that extends from base 103, mechanical arm 107 that extends from base 103, a timer 109 that controls mechanical arm 107 with motor 111, lid 113 that extends from mechanical arm 107, and candle 115. Base 103 is a platform that allows the total apparatus to be able to stand on its own. Rod 105 is attached to base 103 and is adjustable in height to match candle 113. Mechanical arm 107 is attached to rod 105 and is also controlled by timer 109 by motor 111. Mechanical arm 107 is adjustable to match the location of candle 115. When timer 109 is manipulated by the user of the current invention, the user may set the time in which the timer will signal an end to the designated time and with motor 111 will activate mechanical arm 107 to swing itself towards candle 115. Mechanical arm 107 is attached to lid 113 which extends from mechanical arm 107 and will snuff out candle 115 when the mechanical arm 107 is activated by timer 109 with motor 111. Lid 113 may be either cone shaped or flat shaped. Lid 113 may a plurality of different shapes to account for the different sizes of candles that may be used by controlled candle care apparatus 101.

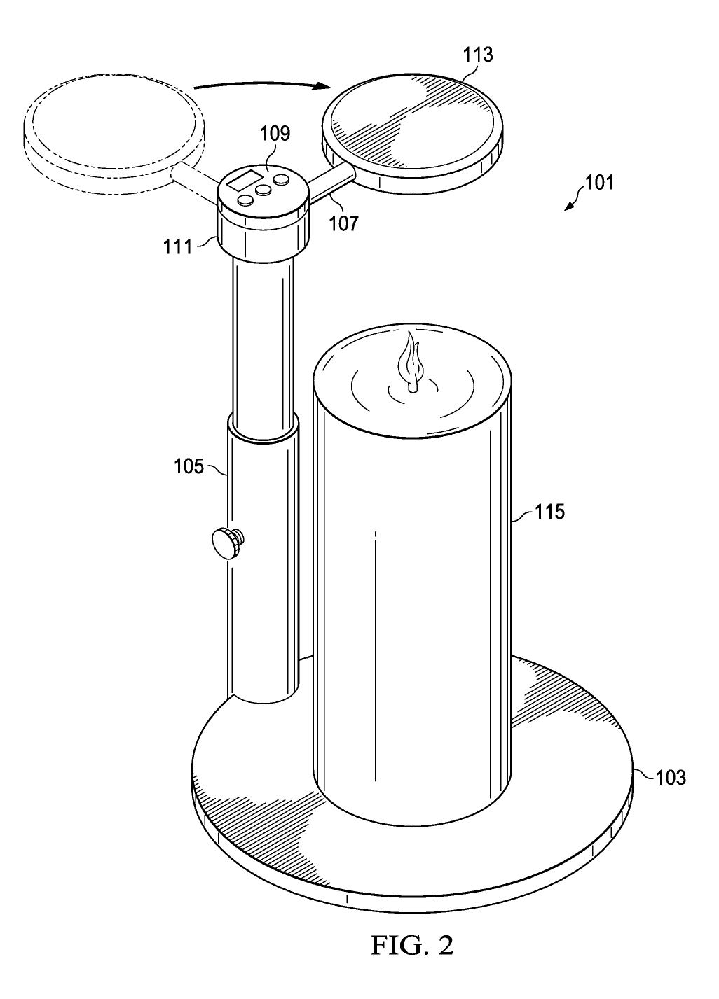

With reference now to FIG. 2, a diagram depicts the movement of the mechanical arm with the lid of the present invention, an embodiment of the current invention. Mechanical arm 107 is attached to rod 105. Mechanical arm 107 can swing in a 180 degree motion. In this position, mechanical arm 107 is in the “on” position. The “on” position is the position in which the candle is allowed to burn and controlled candle care apparatus 101 is in the ready position to turn the candle “off”. Mechanical arm 107 is controlled by timer 109 and motor 111. When timer 109 is manipulated by the user of the current invention, the user may set the time in which the timer will signal an end to the designated time and with motor 111 will trigger mechanical arm 107 to swing in a 180 degree motion with lid 113 to move to the position on rod 105 where lid 113 will slide down to cover candle 115.

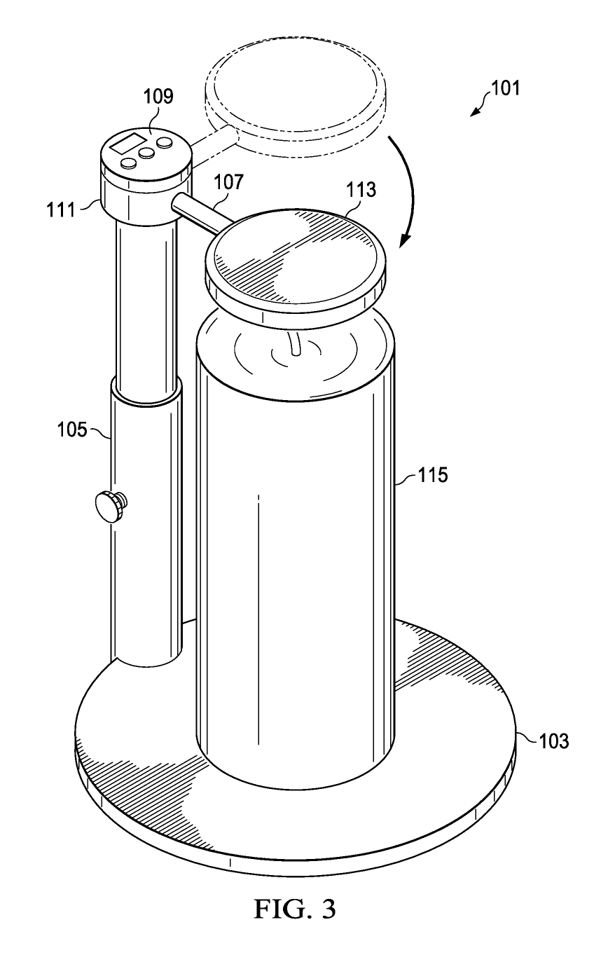

With reference now to FIG. 3, a diagram depicts the current invention, an embodiment of the current invention, covering the candle. Mechanical arm 107 is attached to rod 105. Mechanical arm 107 is attached to lid 113 which extends from mechanical arm 107 and will snuff out candle 115 when the mechanical arm 107 is activated by timer 109 with motor 111. In this position, mechanical arm 107 is in the “off” position. The “off” position is the position in which the candle is ready to be turned “off” and the candle care apparatus 101 has been activated to turn the candle “off”. Lid 113 may be either cone shaped or flat shaped. Lid 113 may a plurality of different shapes to account for the different sizes of candles that may be used by controlled candle care apparatus 101.

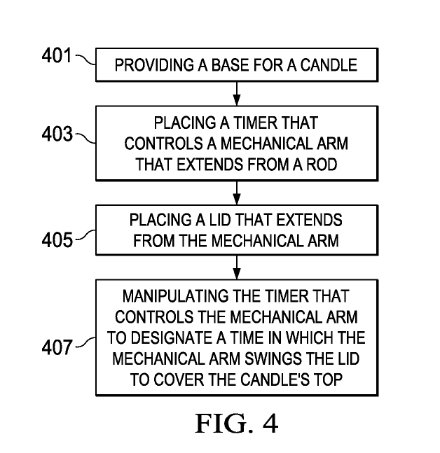

With reference now to FIG. 4, a block diagram depicts the method of making the current invention. A method of making a controlled candle care apparatus comprises: providing a base for a candle (step 401), placing a timer that controls a mechanical arm that extends from a rod (step 403); placing a lid that extends from the mechanical arm (step 405); and manipulating the timer that controls the mechanical arm to designate a time in which the mechanical arm swings the lid to cover the candle's top (step 407). The method of making a controlled candle care apparatus comprises the rod which is adjustable to match the height of the candle. Also, the method of making a controlled candle care apparatus comprises the mechanical arm which is adjustable to match the location of the candle. It is understood that the embodiment of this method is merely illustrative and that the method of making a controlled candle care apparatus is not limited or intended to be limited to these steps.

While the present invention has been described with reference to particular embodiments, it will be understood that the embodiments are merely illustrative and that the invention scope is not so limited. Any variations, modifications, additions, and improvements to the embodiments described are possible. These variations, modifications, additions, and improvements may fall within the scope of the inventions as detailed within the following claims.

Insofar as the description above and the accompanying drawings disclose any additional subject matter that is not within the scope of the single claim below, the illustrative embodiments are not dedicated to the public and the right to file one or more applications to claim such additional embodiments is reserved.

What is claimed is:

1. An apparatus for controlled candle care comprising: a base, a rod that extends from the base, a mechanical arm that extends from the base, a timer that controls the mechanical arm with a motor, a lid that extends from the mechanical arm, and a candle.

2. The apparatus for controlled candle care of claim 1 wherein the rod that extends from the base is adjustable to match the height of the candle.

3. The apparatus for controlled candle care of claim 1 wherein the mechanical arm that extends from the base is adjustable to match the location of the candle.

4. The apparatus for controlled candle care of claim 1 wherein the lid that extends from the mechanical arm is cone shaped.

5. The apparatus for controlled candle care of claim 1 wherein the lid that extends from the mechanical arm is flat shaped.

6. A method of making a controlled candle care apparatus comprising: providing a base for a candle; placing a timer that controls a mechanical arm that extends from a rod; placing a lid that extends from the mechanical arm; and manipulating the timer that controls the mechanical arm to designate a time in which the mechanical arm swings the lid to cover the candle's top.

7. The method of making a controlled candle care apparatus of claim 6 wherein the rod is adjustable to match the height of the candle.

8. The method of making a controlled candle care apparatus of claim 6 wherein the mechanical arm is adjustable to match the location of the candle.
